(19) United States
(12) Patent Application Publication
(10) Pub. No.: US 2011/0033368 A1
(43) Pub. Date: Feb. 10, 2011

(54) METHODS OF FORMING A NANOCRYSTAL

(75) Inventors: Enyi Ye, Singapore (SG); Yin Win Khin, Singapore (SG); Mingyong Han, Singapore (SG)

Correspondence Address: SEED INTELLECTUAL PROPERTY LAW GROUP PLLC, 701 FIFTH AVE, SUITE 5400, SEATTLE, WA, 98104, US

(73) Assignee: AGENCY FOR SCIENCE, TECHNOLOGY AND RESEARCH, Singapore (SG)

(21) Appl. No.: 12/681,771

(22) PCT Filed: Oct. 3, 2008
(86) PCT No.: PCT/SG08/00381

§ 371 Date: Nov. 1, 2010

Related U.S. Application Data
(60) Provisional application No. 60/977,792, filed on Oct. 5, 2007.

(51) Int. Cl. C01B 19/04; C01B 19/00; C01G 49/02; C01G 45/02; C01G 9/02; C01G 51/04; B82Y 99/00

(52) U.S. Cl. 423/509; 423/508; 423/594.1; 423/594.2; 423/605; 423/622; 423/594.19; 977/810

(57) ABSTRACT

Methods of forming a nanocrystal are provided. The nanocrystal may be a binary nanocrystal of general formula M1A or of general formula M1O, a ternary nanocrystal of general formula M1M2A, of general formula M1AB or of general formula M1M2O or a quaternary nanocrystal of general formula M1M2AB. M1 is a metal of Groups II-IV, Group VII or Group VIII of the PSE. A is an element of Group VI or Group V of the PSE. O is oxygen. A homogenous reaction mixture in a non-polar solvent of low boiling point is formed, that includes a metal precursor containing the metal M1 and, where applicable M2. For an oxygen containing nanocrystal the metal precursor contains an oxygen donor. Where applicable, A is also included in the homogenous reaction mixture. The homogenous reaction mixture is under elevated pressure brought to an elevated temperature that is suitable for forming a nanocrystal.

### CROSS-REFERENCE TO RELATED APPLICATIONS

This application makes reference to and claims the benefit of priority of an application for a “Solvothermal Synthesis of High Purity Binary and Ternary Nanocrystals” filed on Oct. 5, 2007 with the United States Patent and Trademark Office, and there duly assigned Ser. No. 60/977,792. The contents of said application filed on Oct. 5, 2007 is incorporated herein by reference for all purposes, including an incorporation of any element or part of the description, claims or drawings not contained herein and referred to in Rule 20.5(a) of the PCT, pursuant to Rule 4.18 of the PCT.

### FIELD OF INVENTION

The present invention relates to methods of forming a nanocrystal.

### BACKGROUND OF THE INVENTION

Semiconductor nanocrystals have made a significant impact on many technological areas including optics, optoelectronic, photoluminescence, electroluminescent devices, biological labelling and diagnostics, and so on. These semiconductor nanocrystals nanocrystals are known for the unique properties they possess as a result of both their size and their high surface area.

Among the most studied semiconductor nanocrystal materials have been the chalcogenide II-VI materials and III-V materials. The primary reason for the interest in these semiconductor nanocrystal materials is their size-tunable photoluminescence emission spanning the whole visible spectrum.

Other nanocrystal materials being studied are the magnetic materials which have found their way into medical use as contrast media for magnetic resonance imaging, hyperthermic treatment of malignant cells, and drug delivery.

There have been increasing interests in developing methods of synthesizing the nanocrystals, in particular II-VI and III-V nanocrystals, which have well-defined shapes, sizes and high crystallinity. Monodisperse nanocrystals with a narrow particle size distribution are an important property of the nanocrystals in various applications because quantum effect is dependent upon their size.

Murray and Bawendi developed a method of preparing nanocrystal in which an organometallic precursor and an elemental precursor are injected into a hot solvent forming nanocrystals (Murray C., Norris D., Bawendi M., J. Am. Chem. Soc. (1993) vol. 115, 19; 8706-8715). This method also called wet chemistry method has been commonly used in the preparation of nanocrystals, particularly II-VI and III-V nanocrystals.

Recently, methods have been developed for producing nanocrystals with core-shell structure or capped structure consisting of a core made of one semiconducting material which is coated with another semiconductor material. For example, U.S. Pat. No. 6,322,901 describes core-shell structured Group II-VI and Group III-V compound semiconductor nanocrystals prepared by forming a compound semiconductor layer on the surface of core nanocrystals.

The surface property of the nanocrystals is significant in determining nanocrystal characteristics. In the methods known, the purification of the nanocrystals which includes multistep precipitation can affect the surface properties of the nanocrystals leading to surface defects. Further, the quantum yield of the nanocrystals can also be affected in the multistep purification of nanocrystals.

It is desirable to provide an alternative method for producing nanocrystals that allows purification of nanocrystals without affecting the surface of the nanocrystals.

### SUMMARY OF INVENTION

According to one aspect the present invention provides a method of forming a binary nanocrystal of the general formula M1A. In this general formula M1 can be a metal of Group II, Group III, Group IV, Group VII or Group VIII of the Periodic System of Elements (PSE). A can be an element of Group VI or Group V of the PSE. The method includes forming a homogenous reaction mixture. This homogenous reaction mixture includes a metal precursor that contains the metal M1. The homogenous reaction mixture also includes the element A. Further, the homogenous reaction mixture also includes a non-polar solvent of low boiling point. The method further includes bringing the homogenous reaction mixture under elevated pressure to an elevated temperature that is suitable for forming a nanocrystal.

According to another aspect, the present invention provides a method of forming a binary nanocrystal of the general formula M1O. In this general formula M1 can be a metal of Group II, Group III, Group I, V Group VII or Group VIII of the PSE. O is oxygen. The method includes forming a homogenous reaction mixture. This homogenous reaction mixture includes a metal precursor. The metal precursor contains the metal M1 and an oxygen donor. The homogenous reaction mixture also includes a non-polar solvent of low boiling point. The method further includes bringing the homogenous reaction mixture under elevated pressure to an elevated temperature that is suitable for forming a nanocrystal.

In a further aspect, the present invention provides a method of forming a ternary nanocrystal of general formula M1M2A. In this general formula M1 and M2 can independent from one another be a metal of Group II, Group III, Group IV, Group VII or Group VIII of the PSE. A can be an element from Group VI or V of the PSE. The method includes forming a homogenous reaction mixture. This homogenous reaction mixture includes a metal precursor. The metal precursor contains the metal M1 and the metal M2. The homogenous reaction mixture also includes the element A. Further, the homogenous reaction mixture includes a non-polar solvent of low boiling point. The method further includes bringing the homogenous reaction mixture under elevated pressure to an elevated temperature that is suitable for forming a nanocrystal.

In yet another aspect, the present invention relates to a method of forming a ternary nanocrystal of the general formula M1AB. In this general formula M1 can be a metal of Group II, Group III, Group IV, Group VII or Group VIII of the PSE. Each of A and B can independent from each other be an element of Group V or Group VI of the PSE. The method includes forming a homogenous reaction mixture. The homogenous reaction mixture includes a metal precursor. The metal precursor contains the metal M1. The homogenous reaction mixture also includes the element A and the element B. Further, the homogenous reaction mixture includes a non-polar solvent of low boiling point. The method also includes bringing the homogenous reaction mixture under elevated pressure to an elevated temperature that is suitable for forming a nanocrystal.

According to another aspect, the present invention relates to a method of producing a ternary nanocrystal of the general formula M1M2O. In this general formula M1 and M2 can independent from one another be a metal of Group II, Group III, Group IV, Group VII or Group VIII of the PSE. O is oxygen. The method includes forming a homogenous reaction mixture. The homogenous reaction mixture includes a metal precursor. The metal precursor contains the metal M1, the metal M2 and an oxygen donor. Further, the homogenous reaction mixture includes a non-polar solvent of low boiling point. The method also includes bringing the homogenous reaction mixture under elevated pressure to an elevated temperature that is suitable for forming a nanocrystal.

In yet another aspect, the present invention relates to a method of forming a quaternary nanocrystal of the general formula M1M2AB. In this general formula M1 and M2 can independent from one another be a metal of Group II, Group III, Group IV, Group VII or Group VIII of the PSE. Each of A and B can independent from each other be a metal of Group II, Group III, Group IV, Group VII or Group VIII of the PSE. The method includes forming a homogenous reaction mixture. The homogenous reaction mixture includes a metal precursor. The metal precursor contains the metal M1 and the metal M2. Further, the homogenous reaction mixture includes the element A and the element B. The homogenous reaction mixture also includes a non-polar solvent of low boiling point. The method further includes bringing the homogenous reaction mixture under elevated pressure to an elevated temperature suitable for forming a nanocrystal.

### BRIEF DESCRIPTION OF DRAWINGS

FIGS. 1a and 1b show a Transmission Electron Microscopy (TEM) image of binary metal chalcogenide PbSe and PbTe, respectively, prepared at elevated pressure in hexane.

FIG. 2 shows a TEM image of binary metal oxide ZnO, formed at elevated pressure in hexane.

FIG. 3 shows a high resolution transmission electron microscopy (HRTEM) image of binary metal oxide MnO nanocrystals prepared at elevated pressure in hexane.

FIG. 4 shows a TEM image of binary metal oxide CoO synthesized at elevated pressure in hexane.

FIG. 5a shows a TEM image of ternary nanocrystals of the formula ZnCdSe. The nanocrystals are nanorods of the composition Zn_{0.22}Cd_{0.78}Se, formed from a reaction mixture of Zn/Cd oleate, in a ratio of about 1:1, the about four fold amount of Se in trioctyl phosphine (TOP) solution, as well as trioctyl phosphine (TOPO), hexadecylamine (HAD), and hexane as the solvent. The mixture was reacted at about 320° C. for about 3.5 hours at elevated pressure.

FIG. 5b shows a TEM image of ternary nanocrystals of ZnCdSe, prepared from a reaction mixture of Zn/Cd oleate, in a ratio of about 1:1, the about four fold amount of Se in TOP, as well as TOPO, HAD, and hexane as the solvent, reacted at about 320° C. for about 3.5 hours without TOPO at 1 atm pressure. The TEM images of 5a and 5b show that the nanocrystals prepared at elevated pressure are nanorods while the nanocrystals prepared without hexane at 1 atm pressure are nanodots. These results indicate that high pressure favours anisotropic growth of nanocrystals.

FIGS. 6a, 6b and 6c show TEM images of ternary metal oxide nanocubes of MgFe₂O₄ CaFe₂O₄ SrFe₂O₄ respectively where the ternary metal oxides can be prepared at elevated pressure in hexane prepared at elevated pressure in hexane.

FIG. 7a depicts a TEM image of ZnFe₂O₄ nanocrystals, FIG. 7b shows a TEM image of CoFe₂O₄ nanocubes, and FIG. 7c shows a TEM image of MnFe₂O₄ nanocubes prepared at elevated pressure in hexane.

FIG. 8a depicts a TEM image of NiFe₂O₄ prepared under ambient conditions. FIG. 8b depicts a TEM image of NiFe₂O₄ prepared under pressure according to the present invention. The TEM image reveals a typical star shaped structure of the nanocrystal formed under pressure that shows improvement in surface properties of the nanocrystals.

FIG. 9 shows a graph illustrating a photoluminescence (PL) spectrum of CdSe QDs prepared via solvothermal method at 180° C. with different reaction time (1=5 min, 2=10 min, 3=30 min. X axis representing wavelength in nm and y axis representing PL intensity.

FIG. 10 shows a graph illustrating a PL spectrum of CdTe quantum dots prepared via solvothermal method at 180° C. for 20 minutes. The x axis represents the wavelength in nm and the y axis represents the PL intensity.

FIG. 11a shows a graph illustrating a PL spectrum of ternary ZnCdSe nanocrystal prepared under pressure in a ratio of Zinc:Cadmium of about 1:1 with TOPO reacted for about 1 hour. FIG. 11b shows a graph illustrating a PL spectrum of ternary ZnCdSe nanocrystal prepared under pressure in a ratio of Zinc:Cadmium of about 1:1 without TOPO reacted for about 2 hours. The x axis represents the wavelength in nm and the y axis represents the PL intensity.

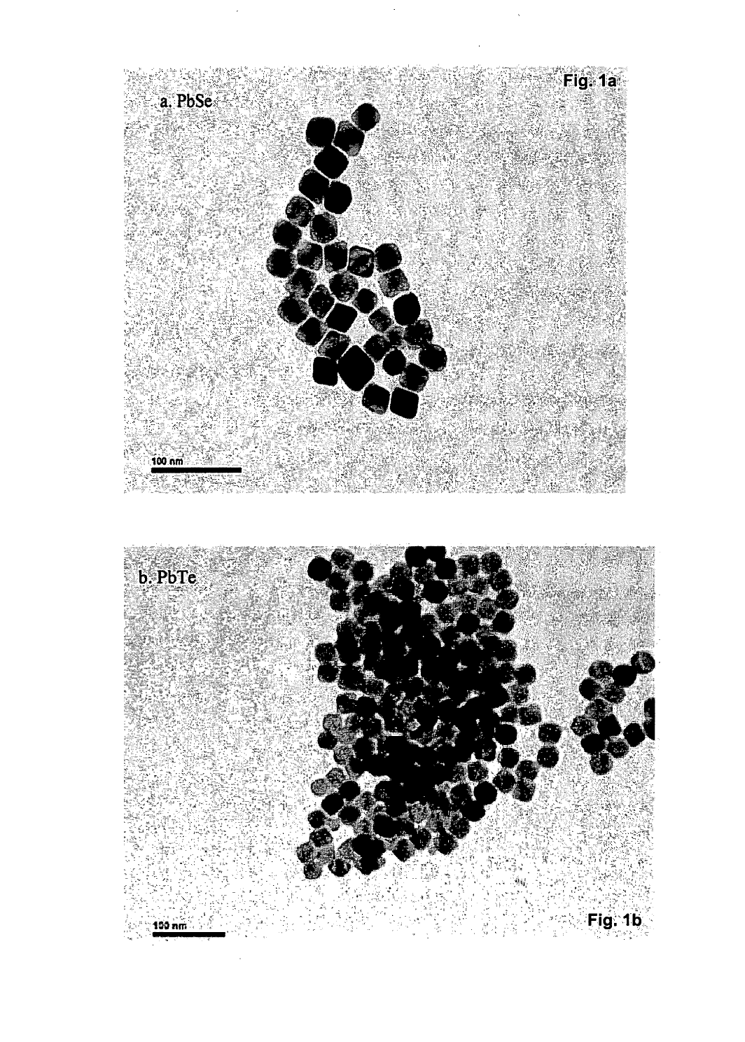

### DETAILED DESCRIPTION OF THE INVENTION

The present invention relates to method of preparing one or more nanocrystals. A corresponding nanocrystal may include or consist of semiconducting matter or a magnetic oxide, including in ternary or higher systems e.g. a metal ferrite. Where the nanocrystal is a quantum dot, its emission may be tunable by composition and/or size.

The present invention is based on the surprising finding that non-polar solvents of low boiling point can be conveniently used in a homogenous phase in a solvothermal process to form nanocrystals. The nanocrystals, which can be obtained at relatively high temperatures, i.e. in a temperature range comparable to conventional methods of forming nanocrystals, are highly crystalline. High quality binary, ternary and quaternary quantum dots and magnetic oxides can be obtained as illustrated in the examples below. Since a solvothermal method is typically carried out in a closed container, no particular inert conditions are usually required. Thus, the corresponding process can be used in large scale production.

Typically nanocrystals are prepared using high temperature reactions. To achieve this high temperature reaction, usually high boiling point solvents are used, in which reactants are refluxed to obtain crystalline nanocrystals (Murray C. B. et al., J. Am. Chem. Soc. 1993, vol. 115, pg 8706). While these high temperature reactions yield high quality nanocrystals, they typically require multistep washing, which is time consuming and bears the risk of affecting the surface properties of the nanocrystals as well as the quantum yield in cases where the nanocrystals are quantum dots. By increasing the number of surface defects, the purity of the nanocrystals obtained are lowered. The use of high-boiling solvents is associated with a number of difficulties, including possible toxicity, expense, and their inability to dissolve simple salts. Furthermore, in the reaction at least one reactant should be quickly injected into a high-temperature solvent which makes the process difficult to carry out in a large scale. In other areas attempts have been performed to circumvent these difficulties by employing solvothermal methods (see Masala, O., &, R., Annu. Rev. Mater. Res. (2004) 34, 41-81; Byrappa, K., et al., Advanced Drug Delivery Reviews (2008) 60, 299-327; Thirumurugan, A., Bull. Mater. Sci. (2007) 30, 2, 179-182.

The term “solvothermal” is derived from the word “hydrothermal”. The term “hydrothermal” is a term commonly used in geology. In the context of synthesis it refers to conditions of elevated pressure and typically also elevated temperature as well as the use of water as catalyst. The term “solvothermal” generally refers to conditions of elevated pressure, and often also elevated temperature, involving a solvent. Accordingly a solvent is used above its boiling point, typically in an enclosed vessel that supports high autogenous pressures. In the context of the invention elevated pressure to any degree may be achieved using conventional devices well known in the art, such as a conventional pressure reactor, a flow cell, a Tuttle type batch reactor or an autoclave. Suitable pressurized reactors may for example be closed hydrogenation reactors of the Parr-type. Where a suitable container is available, a static pressure of up to 4×10⁶ atm, ˜400 GPa and above may be generated by means of a diamond anvil cell, albeit such pressures are by no means required to carry out the methods of the invention. In typical embodiments a method according to the present invention is carried out at an elevated pressure in the range from about 10 to about 500 atm (1 atm, such as in the range from about 20 atm to about 200 atm, from about 10 atm to about 200 atm, from about 35 atm to about 150 atm or from about 50 atm to about 100 atm. Above a certain temperature and pressure the solvent becomes a supercritical fluid that exhibits high viscosity and easily dissolves chemical compounds, which under ambient conditions show only low solubility.

Conducting the reaction under elevated pressure, for example in a pressurized reactor allows the use of a non-polar, e.g. hydrophobic, solvent of low boiling point, which can be heated to a temperature above its boiling point by an increase in autogenous pressure resulting from heating. The inventors surprisingly found that this allows the reaction to be carried out at high temperature at which high crystalline nanocrystals can be obtained even with non-polar solvents of low boiling points. In an illustrative example, the homogenous reaction mixture can be transferred to a Parr reactor and purged with nitrogen gas. The mixture can be heated to an elevated temperature, which may also be referred to as the reaction temperature, (˜200° C. to ˜450° C.) at elevated pressure. The mixture may be prevented from statically resting and be affected to maintain at least a slight current of measurable degree. In some embodiments the mixture is accordingly exposed to mixing, typically continuous mixing. For this purpose it may be kept under flow. The mixture may thus be kept in frequent or continuous motion. This may for instance be achieved by agitation, including stirring, e.g. mechanical stirring, sonification, rolling, shaking and combinations thereof. The reaction temperature can be maintained for sufficient time to allow formation of nanocrystals. After the completion of the reaction, the reaction can then be stopped by simply removing the heat and cooling down. The final product can be purified by simple centrifugation/dispersion process. It is noted in this regard that due to the elevated pressure used the reaction may be carried out at reaction temperatures that are significantly higher, e.g. 50° C., 100° C., 200° C. or 300° C. higher than the boiling point of the solvent used (see also below) at atmospheric pressure. The reaction mixture may for instance be brought, e.g. warmed, to a temperature from about 50° C. to about 500° C., such as about 50° C. to about 400° C., about 100° C. to about 400° C., about 100° C. to about 350° C., about 100° C. to about 300° C., about 150° C. to about 350° C., about 200° C. to about 350° C. or about 250° C. to about 350° C.

Further, the inventors found that the use of non-polar solvents with a low boiling point can substantially reduce the post-treatment or purification steps. It has also surprisingly been found by the inventors that producing nanocrystals, including quantum dots, at elevated pressures can allow modulation of morphologies of certain nanocrystals resulting in high crystallinity and anisotropic growth of nanocrystals.

In addition, among the suitable solvents with a low boiling point (see below) solvents of much lower cost are available than among those solvents with a high boiling point. Accordingly the costs of forming nanocrystals can be significantly reduced by employing the methods of the present invention, particularly in large scale production.

Depending on the reaction conditions used, the methods of the present invention encompass embodiments of forming a binary, a tertiary and a quaternary nanocrystal. Where a binary nanocrystal is formed, this nanocrystal may in some embodiments be of the general formula M1A. M1 in this formula can be a metal of Group II, Group III, Group IV, Group VII or Group VIII of the Periodic System of Elements (PSE) according to the traditional IUPAC system. According to the new IUPAC system the corresponding groups (traditional system in brackets) are group 2/group 12 (group II), group 13 (group III), group 14 (group IV), group 7 (group VII). Suitable examples of group II are (group 12 of the new IUPAC system) Cd, Zn, as well as (group 2 of the new IUPAC system) Mg, Sr, Ca, and Ba. Suitable examples of group III are (group 13 of the new IUPAC system) Al, Ga, and In. Two illustrative examples of a suitable element of group IV are (group 14 of the new IUPAC system) Pb and Sn. An illustrative example of a suitable element of group VII is (group 7 of the new IUPAC system) Mn. Suitable examples of elements of group VIII are (group 8 of the new IUPAC system) Fe, Co, Ni, and Ir.

Generally, in the formation of a nanocrystal according to a method of the invention, M1, or where applicable each of M1 and M2, may for instance be of the Group II, such as Cd, Zn, Mg, Sr, Ca, or Ba, of the Group III, such as Al, Ga, and In, of the Group N, such as Pb, Sn, of the Group VII, such as Mn or of the Group VIII, such as Fe, Co, Ni or Ir.

A in the above formula can be a chalcogen or a pnictogen, i.e. an element of Group VI or Group V of the PSE according to the historic IUPAC nomenclature or of group 16 or group 15 according to the new IUPAC nomenclature. The homogenous reaction mixture includes in such embodiments a metal precursor containing the metal M1, as well as the element A. A metal precursor as used in any method according to the present invention is a compound, including a salt, that provides the corresponding metal in the formation of a nanocrystal. It may for instance be an inorganic (e.g. a carbonate) or an organic (e.g. an acetate, a stearate or an oleate) salt of the corresponding metal. Where two metals or metal precursors are used, e.g. cadmium and zinc or oxides thereof, the two metals/precursors may be used in any desired ratio.

Generally, in the formation of a nanocrystal according to a method of the invention, the element A and, where applicable, the element B can be independently selected of Group VI of the PSE, such as of S, Se, Te, O, or Group V of the PSE, such as P, Bi or As. In some embodiments the element A and/or the element B can be dissolved in a suitable solvent before being provided in order to form the reaction mixture.

In some embodiments, the metal precursor can be a metal oleate, for example, cadmium oleate, cadmium zinc oleate, lead oleate, manganese oleate, magnesium oleate, cadmium lead oleate, magnesium ferrous oleate, manganese ferrous oleate, calcium ferrous oleate, zinc ferrous oleate, strontium ferrous oleate, cobalt ferrous oleate, or nickel ferrous oleate. As an illustrative example, in embodiments where a quaternary nanocrystal is formed, the metal precursor can be formed by dissolving the salts of metal M1 and M2 independently in an organic acid, for instance at a temperature of about 80 to about 500° C., such as about 100 to about 400° C. The metal precursor can then be mixed with element A and element B and the non-polar solvent of low boiling point, in order to form the homogeneous reaction mixture. As an illustrative example, the homogenous reaction mixture is formed at a temperature from about 20° C. to about 70° C. In embodiments where the metal precursor is formed at a higher temperature, it may be cooled down before adding to the reaction mixture. Where a ternary nanocrystal such as M1M2A, M1AB, or M1M2O is formed, the metal precursor can likewise be formed by dissolving the salts of metal M1 and M2 independently in an organic acid at about 100 to about 400° C. The metal precursor can then be mixed with element A and/or element B, as well as the non-polar solvent of low boiling point, to form the reaction mixture. The reaction mixture may for instance be formed at a temperature from about 20° C. to about 70° C. The metal precursor formed at high temperature may be cooled down before element A and/or element B is added.

A metal precursor containing the metal M1 can for instance be formed by dissolving a salt of the metal M1 in an organic acid at 100° C. to 450° C. The metal precursor thus formed is then contacted and combined with the element A and a non-polar solvent of low boiling point to form a homogenous reaction mixture. In an illustrative example, the reaction mixture is formed at a temperature from about 20° C. to about 70° C. The metal precursor may in such embodiments be cooled to a selected temperature before adding to form the reaction mixture.

In other embodiments where a binary nanocrystal is formed, the nanocrystal may be of the general formula M1O. M1 in this formula can be a metal of Group II, Group III, Group IV, Group VII or Group VIII of the PSE (cf. above). In such embodiments the homogenous reaction mixture formed includes a metal precursor containing the metal M1. The metal precursor may also include an oxygen donor (cf. below).

A binary nanocrystal of general formula M1A prepared by a method of the present invention may for example be of the formula CdSe, CdTe, CdS, PbSe, PbTe, PbS, SnSe, ZnS, ZnSe, or ZnTe. A binary nanocrystal of general formula M1O prepared according to a method of the present invention can for example be of the formulas CdO, PbO, MnO, CoO, ZnO, or FeO. In this context it is noted that the representation M1A and M1O should only illustrate that this nanocrystals are binary, meaning that they comprise two elements. The representation M1A and M1A does not necessarily represent the stoichiometry of the nanocrystals (even though it can in the case of CdSe or CdO, to recite only two examples) but also includes nanocrystals of the stoichiometry MO₂ (for example MnO₂), M₂O₃ (for example, Al₂O₃), or M₃O₄ (for example Fe₃O₄).

A ternary nanocrystal formed according to a method of the present invention may in some embodiments be of the general formula M1M2A. M1 and M2 in this formula can independently be a metal of Group II, Group III, Group IV, Group VII or Group VIII of the PSE. A can be an element from Group VI or V of PSE. In other embodiments a ternary nanocrystal formed according to a method of the present invention may be of the general formula M1AB. M1 can in this formula be a metal of Group II, Group III, Group IV, Group VII or Group VIII of the PSE. A and B can independently be an element of Group V or Group VI of the PSE. In yet another embodiment a ternary nanocrystal formed according to a method of the present invention may be of the general formula M1M2O. M1 and M2 can be independently a metal of Group II, Group III, Group IV, Group VII or Group VIII of the PSE. O is oxygen. A ternary nanocrystal formed according to a method of the invention may be of any structure. It may for instance be of layered structure, such as a core/shell structure, or it may be homogenous, e.g. of uniform composition or of gradually or stepless varying composition.

A quaternary nanocrystal formed according to a method of the present invention may in some embodiments be of the general formula M1M2AB. As defined above, M1 and M2 can be a metal of Group II, Group III, Group IV, Group VII or Group VIII of the PSE. A and B can independently be an element of Group V or Group VI of the PSE. Those skilled in the art will appreciate that also ternary and quaternary nanocrystals formed during a method according to the invention are typically of high uniformity.

Illustrative examples of a ternary nanocrystal of the general formula M1M2A include, but are not limited to, a ternary nanocrystal of formulas ZnCdSe, CdZnS, CdZnSe, CdZnTe, SnPbS, SnPbSe, and SnPbTe. Illustrative examples of a ternary nanocrystal of general formula M1AB that may be formed using a method of the invention include a nanocrystal of formulas CdSeS, CdSeTe, CdSTe, ZnSeS, ZnSeTe, ZnSTe, SnSeS, SnSeTe, SnSTe, PbSeS, PbSeTe, and PbSTe. Illustrative examples of a ternary nanocrystal of formula M1M2O that may be formed using a method of the invention also include a nanocrystal of the general formula M1M2₂O₄ such as the ferrites MgFe₂O₄, CaFe₂O₄, SrFe₂O₄, ZnFe₂O₄, NiFe₂O₄, CoFe₂O₄, and MnFe₂O₄. In this context it is noted that also the representations M1M2A, M1 AB, and M1M2O merely serve in illustrating the fact that these nanocrystals are ternary, meaning that they include three different elements. Accordingly, from the representation M1M2A, M1AB and M1M2O no conclusion in terms of the stoichiometry of the nanocrystal can be drawn, even though in some embodiments by coincidence, for example in embodiments of CdZnSe, CdSeTe or MgFe₂O₄, the stoichiometry of the nanocrystal could be rather accurately read into the general formula. Hence, the above general formulas M1M2A, M1AB, and M1M2O also include for instance nanocrystals of the stoichiometry M1₁₋ₓM2ₓA (for example Cd₁₋ₓ,ZnₓSe), M1ₓM2₁₋ₓA (for example, ZnₓCd₁₋ₓSe), or M1ₓA_{y}B_{1-y}(for example CdSe_{y}S_{1-y}), M1ₓA_{1-y}B_{y} (for example CdSe_{1-y}S_{y}) or M1₁₋ₓM2ₓO (for example, or Mg₁₋ₓFeₓO) or M1ₓM2₁₋ₓO (for example, FeₓMn₁₋ₓO).

Illustrative examples of a quaternary nanocrystal of general formula M1M2AB that may be formed using a method of the invention include a nanocrystal of CdZnSeS, CdZnSeTe, CdZnSTe, CdHgSeS, CdHgSeTe, CdHgSTe, HgZnSeS, HgZnSeTe and HgZnSTe. In this context it is noted that also the representation M1M2AB, should only illustrate that this nanocrystals are quaternary, meaning that they comprise four elements. The representation M1M2AB does not necessarily represent the stoichiometry of the nanocrystals (even though it can in the case of CdZnSeS, to recite only one example) but also includes nanocrystals of the stoichiometry M1₁₋ₓ M2ₓA_{y}B_{1-y} (for example Cd1-xZnxSe_{y}S_{1-y}), or M1₁₋ₓM2ₓA_{1-y} (for example Cd₁₋ₓZnxSe_{1-y}S_{y}).

It is further noted that independent of whether a binary, a ternary or a quaternary nanocrystal is formed, and the methods of the invention allow a broad flexibility of reaction conditions, such that the respective nanocrystal may be of any desired structure. It may for instance be of a layered structure, e.g. a core/shell structure or a core-mantle-shell structure, (Hines, M. A., & Guyot-Sionnest, P., J. Phys. Chem. (1996) 100, 468; Dabbousi, B. O., et al., J. Phys. Chem. B (1997) 101, 9463; Peng, X., et al., J. Am. Chem. Soc. (1997) 119, 7019 16-18) or of any alloy structure (see for example U.S. Pat. No. 7,056,471), including alloy-gradient structure (Foley, J., et al., Materials Science Forum, vols. 225-227 (1996) pp. 323-328) or a “mantel structure” having a core surrounded by a relatively thin alloyed layer and a shell as described in co-pending PCT application PCT/SG2008/000290 “Process Of Forming A Cadmium And Selenium Containing Nanocrystalline Composite And Nanocrystalline Composite Obtained Therefrom”, the entire disclosure of which is incorporated by reference herein.

As already indicated above, in any method according to the present invention a homogenous reaction mixture is formed. The reaction mixture thus has only one phase, rather than e.g. an insoluble suspension or emulsion. The reaction mixture may also be of a temporarily stable or metastable phase, as long as during a selected period of time for forming a nanocrystal no phase separation occurs. The homogenous reaction mixture may for example be a homogenous solution. The reaction mixture includes a non-polar solvent, such as a hydrophobic solvent, of low boiling point. Where a nanocrystal of general formula M1M2A is formed, the homogenous reaction mixture includes a metal precursor that contains the metals M1 and M2. The homogenous reaction mixture also includes A. Where a nanocrystal of general formula M1AB is formed, the homogenous reaction mixture includes a metal precursor that contains the metal M1. The homogenous reaction mixture further includes A and B. Where a nanocrystal of general formula M1M2O is formed, the homogenous reaction mixture includes a metal precursor that contains the metals M1 and M2. Further, in such embodiments the metal precursor includes an oxygen donor. Where a quaternary nanocrystal of the general formula M1M2AB is formed, the method may include forming a homogenous reaction mixture that includes a metal precursor containing the metal M1 and M2, the element A and the element B. In any case the homogenous reaction mixture is brought, e.g. heated, under elevated pressure to a reaction temperature suitable for forming nanocrystals.

The term “oxygen donor” as used herein is understood to refer to any moiety, group, ion or compound that is capable of providing oxygen, for instance for an oxidation, in the formation of a nanocrystal. The oxygen donor may be of organic or inorganic nature. Illustrative examples of an oxygen donor are NO₃⁻, HCO₃⁻, CO₃²⁻, ClO₃⁻, ClO₄⁻, SO₃²⁻ or SO₄²⁻. A further illustrative example is a carboxylic acid or its corresponding anion, generally in a salt of the corresponding metal. Acetate, formiate, propionate or acetylacetonate are examples of suitable carboxylic acids. For the sake of completeness it is noted that in the case of a carboxylic acid that has no further functional group, the moiety —COO⁻ or COOH may often be taken to represent the oxygen donor rather than the entire carboxylic acid. For illustration purposes it is added that, where a nanocrystal of the general formula M1M2A is formed, A may for instance be S, Se or Te. In such an embodiment the respective chalcogen may be added during the formation of the reaction mixture. In contrast thereto, in the case of the formation of a nanocrystal of the general formula M1M2O a metal precursor is generally added to the reaction mixture that includes an oxygen donor, thereby already providing the element O.

A method of the invention may further include adding a surfactant. The surfactant may be added during the formation of the reaction mixture, for example before or after adding the one or more metals or metal precursors, before or after adding a chalcogen or a pnictogen, where applicable, or at the same time as one of these reactants is added. Any surfactant may be used. The surfactant may for instance be an organic carboxylic acid, an organic phosphate, an organic phosphonic acid, an organic phosphine oxide, an organic amine or a mixture thereof. A suitable organic carboxylic acid may for example have about 8 to about 18 main chain atoms, for example about 8 to about 18 main chain carbon atoms. Illustrative examples of suitable organic carboxylic acid include, but are not limited to, stearic acid (octadecanoic acid), lauric, acid, oleic acid ([Z]-octadec-9-enoic acid), n-undecanoic acid, linoleic acid, ((Z,Z)-9,12-octadecadienoic acid), arachidonic acid ((all-Z)-5,8,11,14-eicosatetraenoic acid), linelaidic acid ((E,E)-9,12-octadecadienoic acid), myristoleic acid (9-tetradecenoic acid), palmitoleic acid (cis-9-hexadecenoic acid), myristic acid (tetradecanoic acid), palmitic acid (hexadecanoic acid) and γ-homolinolenic acid ((Z,Z,Z)-8,11,14-eicosatrienoic acid). Examples of other surfactants (an organic phosphonic acid, for example) include hexylphosphonic acid and tetra decylphosphonic acid. It has previously been observed that oleic acid is capable of stabilising nanocrystals and allows the usage of octadecene as a solvent (Yu, W. W., & Peng, X., Angew. Chem. Int. Ed. (2002) 41, 13, 2368-2371). In the synthesis of other nanocrystals surfactants have been shown to affect the crystal morphology of the nanocrystals formed (Zhou, G., et al., Materials Lett. (2005) 59, 2706-2709). Any organic phosphine or phosphine oxide may be used, such as an oil-soluble phosphine-based or phosphine oxide-based material, in particular with a boiling point of 40° C. or higher. Examples of phosphines include, but are not limited to, triphenylphosphine (CAS No. 603-35-0), tributyl-phosphine (CAS No 998-40-3), trioctylphosphine (CAS No 4731-53-7), trilaurylphosphine (CAS No 6411-24-1), tripentadecylphosphine (CAS No 72931-32-9), trioctadecylphosphine (CAS No 39240-11-4), 2,2′-(cyclohexylphosphinidene)bis-pyridine (CAS No 380358-80-5) 2,2′-bis(diphenylphosphino)-1,1′-binaphthyl (CAS No 98327-87-8) and 1-[2-(diphenylphosphino)phenyl]-2,5-dimethyl-phospholane (CAS No 491610-06-1). Three illustrative examples of an organic phosphine oxide are trioctyl phosphine oxide (CAS No 78-50-2), tris(2-pyridyl)phosphine oxide (CAS No. 26437-49-0), triphenyl phosphine oxide (CAS No 791-28-6), tri-2,4-xylylphosphine oxide (CAS No 52944-84-0), tris(3,5-dimethylphenyl)-phosphine oxide (CAS No 381212-20-0), tris(2-methyl-2-propenyl)-phosphine oxide (CAS No 94037-62-4), 2,2′,2″-phosphinylidynetris[4-methoxy-pyridine (498578-67-9), as well as e.g. alkyldimethyl phosphine oxides or alkyldiethyl phosphine oxides.

A suitable organic amine may for instance be an alkylamine that may have from about 3 to about 30 main chain atoms, e.g. main chain carbon atoms, or an alkenylamine that may have from about 2 to about 18 main chain atoms, e.g. main chain carbon atoms. As a further example, the surfactant can be an alkyl amine that has from about 3 to about 30 main chain atoms, e.g. main chain carbon atoms. Examples of a suitable amine include, but are not limited to, hexadecylamine, oleylamine, octadecylamine, bis(2-ethylhexyl)amine, octylamine, dioctylamine, trioctylamine, dodecylamine/laurylamine, didodecylamine tridodecylamine, hexadecylamine, dioctadecylamine, and trioctadecylamine.

The term alkyl as used herein refers to a saturated aliphatic or an alicyclic moiety. The term alkenyl as used herein refers to an unsaturated aliphatic or an alicyclic moiety that includes one or more double bonds, generally in the form of —C═C— units, for example —CH═CH— groups. In the context of an aliphatic moiety an alkyl or alkenyl moiety are, unless otherwise stated, a straight or branched hydrocarbon chain, which may be saturated or mono- or poly-unsaturated and include one or more heteroatoms. A heteroatom is any atom that differs from carbon. In typical embodiments a heteroatom forms a covalent bond to a carbon atom. Examples include, but are not limited to N, O, P, S, Si and Se. In some embodiments of an alkyl- or alkenyl moiety several heteroatoms are present within the same moiety. The hydrocarbon chain may, unless otherwise stated, be of any length, and contain any number of branches. The branches of the hydrocarbon chain may include linear chains as well as non-aromatic cyclic elements. Typically, the hydrocarbon (main) chain includes 1 to about 4, 1 to about 5, 1 to about 6, 1 to about 7, 1 to about 8, 2 to about 4, 2 to about 5, 2 to about 6, 3 to about 4, 3 to about 5, 3 to about 6, 1 to about 10, 1 to about 14, 1 to about 18, 2 to about 18, 1 to about 20, 1 to about 22 or 1 to about 26 carbon atoms.

Examples of alkenyl radicals are straight-chain or branched hydrocarbon radicals which contain one or more double bonds. Alkenyl radicals normally contain about two to about 25 carbon atoms and one or more, for instance two, double bonds, such as about two to about ten carbon atoms, and one double bond. Examples of alkyl groups are methyl, ethyl, propyl, butyl, pentyl, hexyl, heptyl, octyl, nonyl, decyl, the n isomers of these radicals, isopropyl, isobutyl, isopentyl, sec.-butyl, tert.-butyl, neopentyl and 3,3-dimethylbutyl. Both the main chain as well as the branches may furthermore contain heteroatoms as for instance N, O, S, Se or Si or carbon atoms may be replaced by these heteroatoms.

In the context of an alicyclic moiety, which may also be referred to as “cycloaliphatic” the alkyl or alkenyl moiety is, unless stated otherwise, a non-aromatic cyclic moiety (e.g. hydrocarbon moiety), which may be saturated or mono- or poly-unsaturated. The cyclic hydrocarbon moiety may also include fused cyclic ring systems such as decalin and may also be substituted with non-aromatic cyclic as well as chain elements. The main chain of the cyclic hydrocarbon moiety may, unless otherwise stated, be of any length and contain any number of non-aromatic cyclic and chain elements. Typically, the hydrocarbon (main) chain includes 3, 4, 5, 6, 7 or 8 main chain atoms in one cycle. Examples of such moieties include, but are not limited to, cyclopentyl, cyclohexyl, cycloheptyl, or cyclooctyl. Both the cyclic hydrocarbon moiety and, if present, any cyclic and chain substituents may furthermore contain heteroatoms, as for instance N, O, S, Se or Si, or a carbon atom may be replaced by these heteroatoms. Alicyclic cycloalkenyl moieties that are unsaturated cyclic hydrocarbons contain generally about three to about eight ring carbon atoms, for example five or six ring carbon atoms. Cycloalkenyl radicals typically have a double bond in the respective ring system. Cycloalkenyl radicals may in turn be substituted.

In some embodiments where a surfactant is added, the surfactant acts or is intended o act as a capping agent. The respective capping agent may for instance be trioctyl phosphine oxide or a C₈-C₁₈ organic carboxylic acid (supra). The C₈-C₁₈ organic carboxylic acid can be for example oleic acid, tri-n-octyl phosphine oxide, decanoic acid, dodecanoic acid, tetradecanoic acid, hexadecyl hexadecanoic acid, octadecanoic acid or n-octanoic acid.

In some embodiments a metal salt used in a method of the invention (supra) can be dissolved in an organic acid. The organic acid for dissolving the salt of e.g. the metal M1 and/or M2 can be a long chain organic carbonic acid, e.g. a carboxylic acid of typically 5 or more main chain atoms, e.g. main chain carbon atoms, including 8 or more main chain atoms, such as about 8 to about 24 main chain atoms, for example of about 8 to about 18 main chain atoms. The long chain carbonic acid can be for example stearic acid (octadecanoic acid), lauric, acid, oleic acid ([Z]-octadec-9-enoic acid), n-undecanoic acid, linoleic acid, ((Z,Z)-9,12-octadecadienoic acid), decanoic acid, dodecanoic acid, tetradecanoic acid, hexadecyl hexadecanoic acid, octadecanoic acid, n-undecanoic acid, linoleic acid, ((Z,Z)-9,12-octadecadienoic acid), arachidonic acid ((all-Z)-5,8,11,14-eicosatetraenoic acid), linelaidic acid ((E,E)-9,12-octadecadienoic acid), myristoleic acid (9-tetradecenoic acid), palmitoleic acid (cis-9-hexadecenoic acid), myristic acid (tetradecanoic acid), palmitic acid (hexadecanoic acid) and γ-homolinolenic acid ((Z,Z,Z)-8,11,14-eicosatrienoic acid), as well as any mixture thereof. Examples of other surfactants (an organic phosphonic acid, for example) include hexylphosphonic acid and tetra decylphosphonic acid. In one embodiment the long chain carbonic acid is oleic acid.

The metal salt of M1 and/or M2 can for instance be an organic or an inorganic salt of the metal M1 of Group IV, Group VII, Group VIII, or Group II or Group III of the PSE.

The inorganic salt of the metal M1 and/or M2 may for example be an oxide, a carbonate, a sulfate or a nitrate. The organic salt of the metal M1 or M2 may be an acetate or the salt of the metal M1 or the metal M2 and a carboxylic acid, for example a long chain organic carbonic acid with about 5 to about 24 main chain carbon atoms (supra).

The reaction may be carried out for any desired period of time, ranging from milliseconds to a plurality of hours. Where desired, the reaction is carried out in an inert atmosphere, i.e. in the presence of gases that are not reactive, or at least not reactive to a detectable extent, with regard to the reagents and solvents used. Examples of a reactive inert atmosphere are nitrogen or a noble gas such as argon or helium. It is however noteworthy that an inert gas atmosphere was found to be generally unnecessary.

The inventors found that the methods of the present invention where forming, including producing, nanocrystals using non-polar solvent of low boiling point at elevated pressure can be suitable for producing binary, ternary, and quaternary nanocrystals. Furthermore, the methods can be suitable for producing e.g. metal chalcogenides and oxides.

In the methods of the present invention, the solvents are typically non-aqueous solvents. By the term solvent is meant both the solvent used for the preparation of the reactants and the non-polar solvent of low boiling point. The solvents can be chosen in such a manner to form a homogenous reaction mixture. Homogeneous reaction mixture means the reactants are in one phase. In an illustrative example, it is desirable to form a homogenous reaction mixture. On using aqueous solvents, two-phase formation can occur as described in US20070004183. The solvent in which a process of forming a nanocrystal according to the invention is carried out is a non-polar solvent, generally an aprotic non-polar solvent. The solvent is of a low boiling point (b.p.), such as a boiling point less than about 150° C. at standard atmospheric pressure (1013 mbar, 101325 Pa or 1 atm), including a boiling point of less than about 120° C., less than about 100° C., less than about 90° C., less than about 80° C., less than about 70° C., less than about 60° C. less than about 50° C. or less than about 45° C. Illustrative examples of a suitable non-polar solvent include a correspondingly low-boiling mineral oil, petrol ether (typically available with a boiling point of about 40-60° C.), hexane (boiling point 69° C.), chloroform (boiling point 61° C.), dichloromethane (b.p. 40° C.), toluene (b.p. 110.6° C.), benzene (b.p. 80.1° C.), heptane (b.p. 98.4° C.), cyclohexane (b.p. 81° C.), pyridine (b.p. 115.2° C.), carbon tetrachloride (b.p. 76.7° C.), carbon disulfide (b.p. 46° C.), dioxane (b.p. 101° C.), diethyl ether (b.p. 34.6° C.), ethyl vinyl ether (b.p. 35° C.), diisopropylether (b.p. 68° C.), and tetrahydrofuran (b.p. 81° C.).

Once the reaction is complete or has reached a desired state, any further progress of the reaction can then be stopped by simply removing the heat and allowing the formed mixture to cool down. The final product can be purified by a simple centrifugation/dispersion process. After centrifugation, the precipitated products can be collected and dried to obtain a powder. Alternatively, the precipitated products can be re-dissolved in an organic solvent such as hexane again for storage purpose. The latter process may also be termed dispersion. Accordingly, a method according to the invention may include isolating one or more nanocrystals formed.

The method of the invention may further include nanocrystal post-processing. Although the nanocrystals obtained by the method of the invention are generally at least essentially or at least almost monodisperse, if desired a step may be performed to narrow the size-distribution (for example as a precaution or a safety-measure). Such techniques, e.g. size-selective precipitation, are well known to those skilled in the art. The surface of the nanocrystal may also be altered, for instance coated.

The present invention also relates to the use of the nanocrystals obtainable, including obtained, according to the methods of the present invention. As an illustrative example, the nanocrystals may be used in the manufacturer of a semiconductor and/or a diagnostic device.

By “comprising” it is meant including, but not limited to, whatever follows the word “comprising”. Thus, use of the term “comprising” indicates that the listed elements are required or mandatory, but that other elements are optional and may or may not be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXAMPLES

### Example 1

### Synthesis of CdSe Quantum Dots

In a typical reaction, 3 mmol (384 mg) CdO was dissolved in 12 mmol (3.84 ml) oleic acid at 260° C. to form a homogeneous solution. After cooling down to room temperature, 30 ml hexane and 3 ml 1M TOP-Se solution were added into the solution. The solution was degassed by bubbling N₂ into the solution for 15 mts. It is subsequently transferred to Parr 4590 reactor, and quickly heated to 180° C. under vigorous stirring. The solution was maintained at this temperature for a duration which can range from 10 mts to 1 hour, and aliquots at different times were taken out for photoluminescence (PL) monitoring. FIG. 9 shows a graph illustrating PL spectra of CdSe QDs. High quality CdSe QDs were obtained. and the Full Width at Half Maximum (FWHM) of its luminescent spectra (˜30 nm) and quantum yield obtained were the same as for QDs prepared in ODE under 1 atm. This demonstrates that CdSe QDs formed via the solvothermal method are monodisperse with regard to their size distribution. It is also demonstrated that the QDs obtained can be simply purified by extracting out the unreacted species with methanol without sacrificing their quantum yield. This compares to the QDs prepared in ODE, where in order to remove the high boiling point ODC, precipitation needs to be carried out, which leads to a great decrease in the quantum yield of the QDs prepared.

### Example 2

### Synthesis of CdTe Quantum Dots

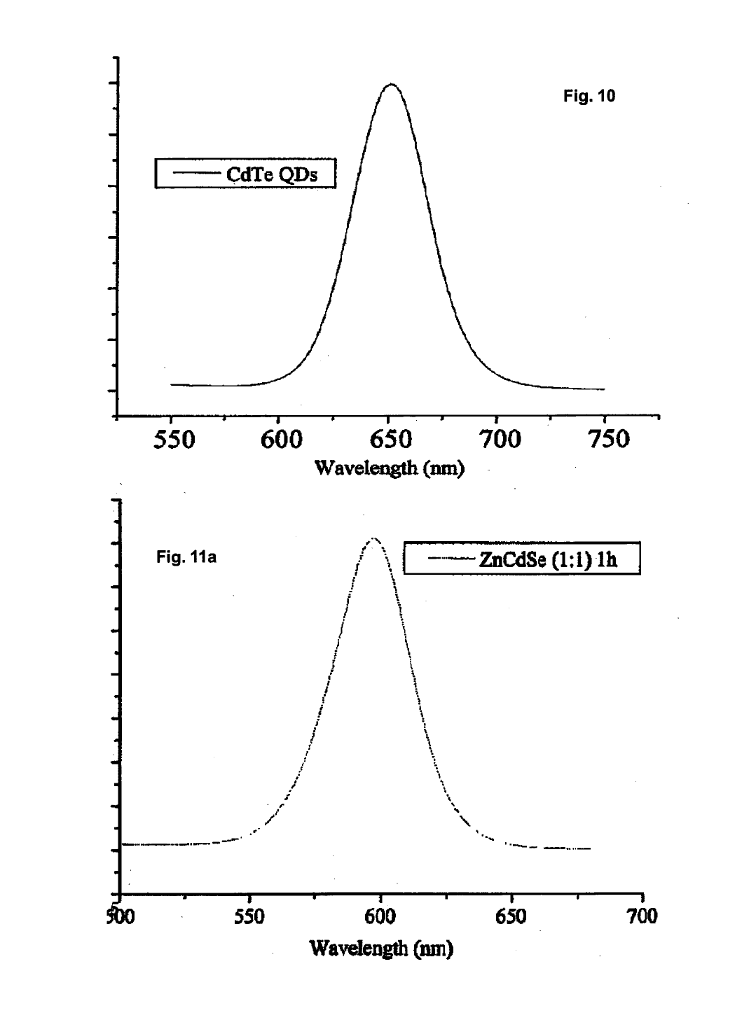

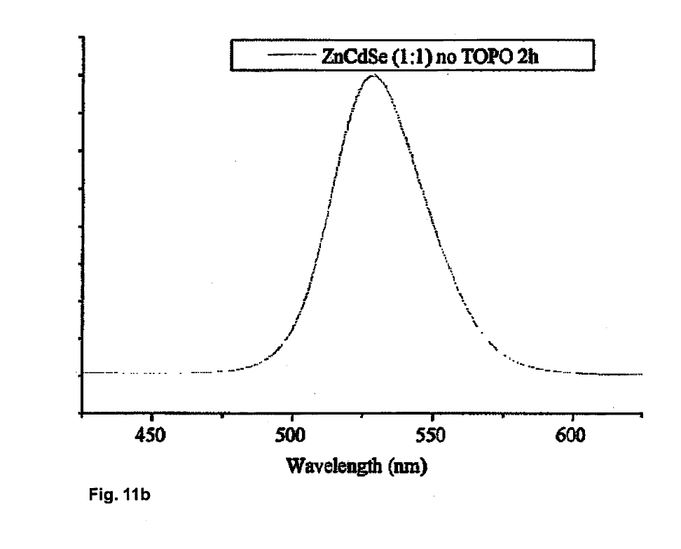

In a typical reaction, 3 mmol (384 mg) CdO was dissolved in 12 mmol (3.84 ml) oleic acid at 260° C. to form a homogeneous solution. After cooling down to room temperature, 30 ml hexane and 3 ml 1M TOP-Te solution were added into the solution. The solution was degassed by bubbling N₂ into the solution for 15 minutes. It is subsequently transferred to Parr 4590 reactor, and quickly heated to 180° C. under vigorous stirring. The solution was maintained at this temperature for a duration which can range from 20 minutes to 60 min, and aliquots were taken out for photoluminescence (PL) monitoring. FIG. 10 depicts a graph illustrating PL spectra of CdTe QDs.

### Example 3

### Synthesis of Binary Metal Oxide ZnO

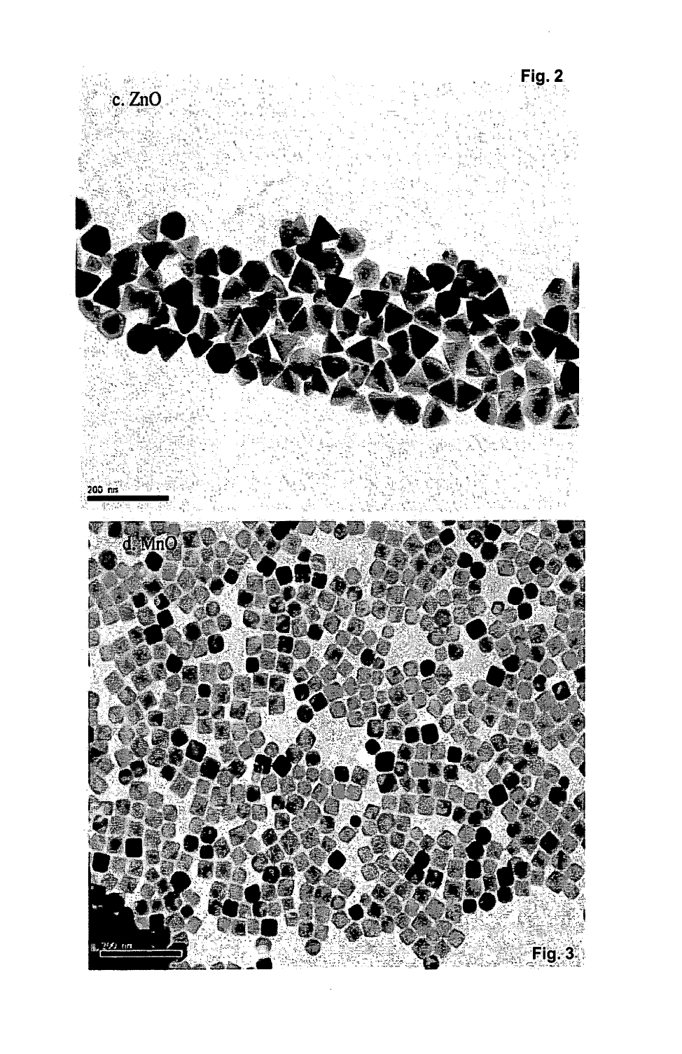

In a typical experiment, 3.0 mmol ZnO was dissolved in 7.5 mmol oleic acid at 260° C. to form a clear solution. After it was cooled down to room temperature, 18 ml hexane and 6 mmol oleylamine were added, then it was transferred to 100 mL Parr reactor 4950 and purged with N₂ gas. The mixture was quickly heated to 320° C. under stirring and maintained at the same temperature for 30 minutes. The reaction was then stopped by simply removing the heat and cooling down. The final product was purified by a simple centrifugation dispersion process, i.e. the precipitated nanocrystals can be collected and dried or be re-dissolved in an organic solvent such as hexane for storage. FIG. 2 shows TEM images of binary metal oxide prepared by the solvothermal method of the invention.

### Example 4

### Synthesis of Binary Metal Oxide MnO

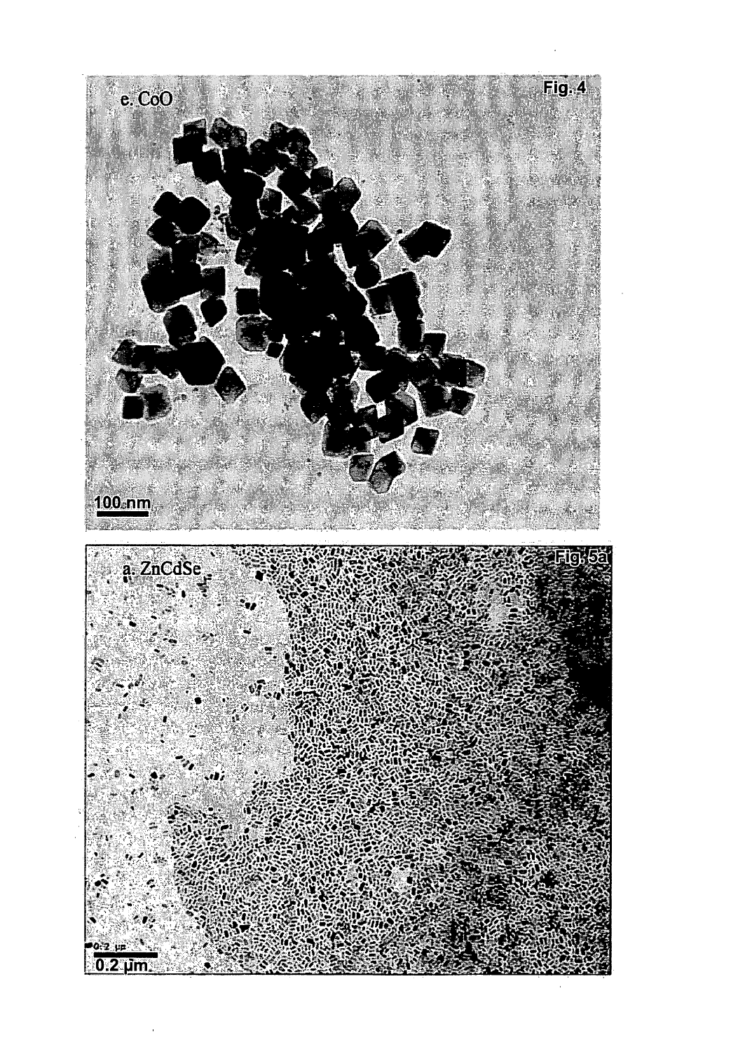

In a typical experiment, 3.0 mmol manganese acetate (MnAc₂) was dissolved in 7.5 mmol oleic acid at 200° C. to form a clear solution. After it was cooled down to room temperature, 20 mL hexane and 6 mL trioctylamine (TOA) were added, then it was transferred to 100 mL Parr reactor 4950 and purged with N₂ gas. The mixture was quickly heated to 320° C. under stirring and maintained at the same temperature for 30 minutes. The reaction was then stopped by simply removing the heat and cooling down. The final product was purified by a simple centrifugation/dispersion process, i.e. the precipitated product can be collected and dried or it can be re-dissolved in an organic solvent such as hexane for storage. FIG. 3 shows a TEM image of binary metal oxide MnO.

### Example 5

### Synthesis of Binary Metal Oxide CoO

In a typical experiment, 3.0 mmol cobalt carbonate (CoCO₃) was dissolved in 7.5 mmol oleic acid at 200° C. to form a clear solution. After it was cooled down to room temperature, 20 mL hexane and 2 mL oleylamine were added, then it was transferred to 100 mL Parr reactor 4950 and purged with N₂ gas. The mixture was quickly heated to 300° C. under stirring and maintained at the same temperature for 1 h. The reaction was then stopped by simply removing the heat and cooling down. The final product was purified by a simple centrifugation/dispersion process, i.e. the precipitated product can be collected and dried, thereby obtaining a powder, or it can be re-dissolved in an organic solvent such as hexane for storage. FIG. 4 shows a TEM image of the binary metal oxide CoO.

### Example 6

### Synthesis of Ternary Quantum Dots ZnCdSe

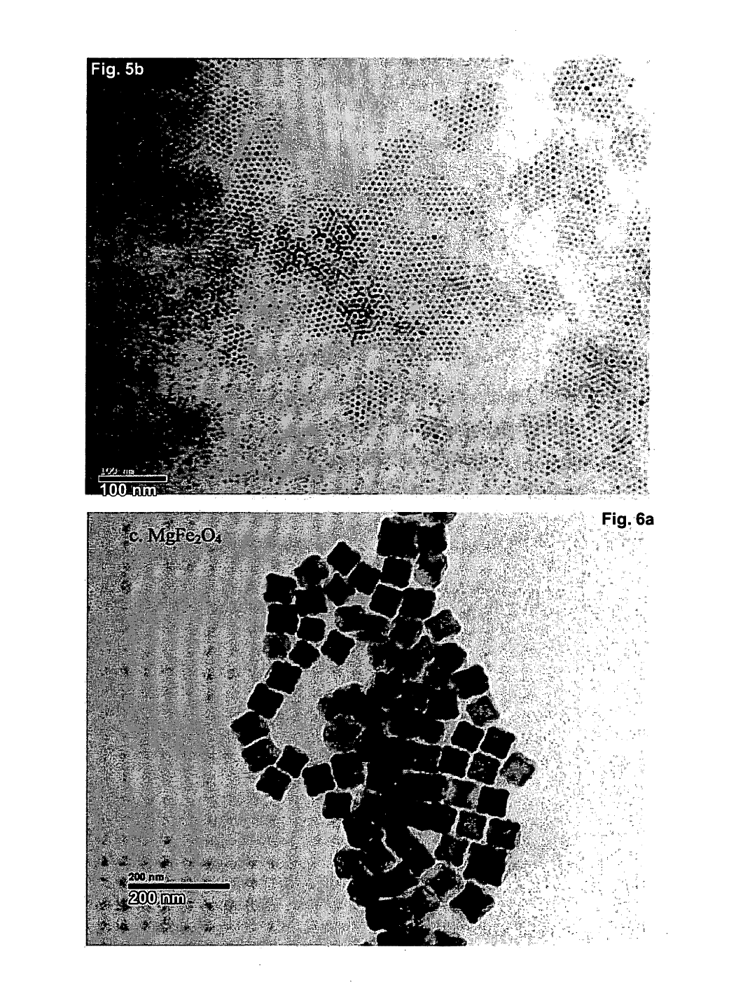

In a typical experiment, 0.3 mmol ZnO and 0.3 mmol CdO were dissolved in 2.4 mmol oleic acid at 320° C. to form a clear homogeneous solution. After it was cooled down to 60° C., 2.4 mL Se solution (1 M TOP-Se solution) and 5 g hexadecylamine (HDA) together with 2 g trioctylphosphineoxide (TOPO) and 20 mL hexane were added; then it was transferred to the 100 mL Parr reactor 4950 and purged with N₂ gas. The mixture was quickly heated to 320° C. under stirring and maintained at the same temperature for 30 mins to 3 h. The reaction was stopped by removing the heat and cooling down. The obtained nanocrystals were purified by a simple centrifugation/dispersion process, i.e. the precipitated nanocrystals can be collected and dried or the precipitated products can be re-dissolved in an organic solvent such as hexane for storage. FIG. 5a shows the TEM image of ZnCdSe prepared by the solvothermal process with hexane. Another experiment was carried out keeping the procedures mentioned above, with change of (i) Zn/Cd ratio of 1:2, 2:1, 1:5 and 5:1; (ii) without any TOPO. FIG. 5b shows a TEM image of ZnCdSe prepared by the solvothermal process without TOPO.

### Example 7

### Synthesis of Ternary Quantum Dots MgFe₂O₄

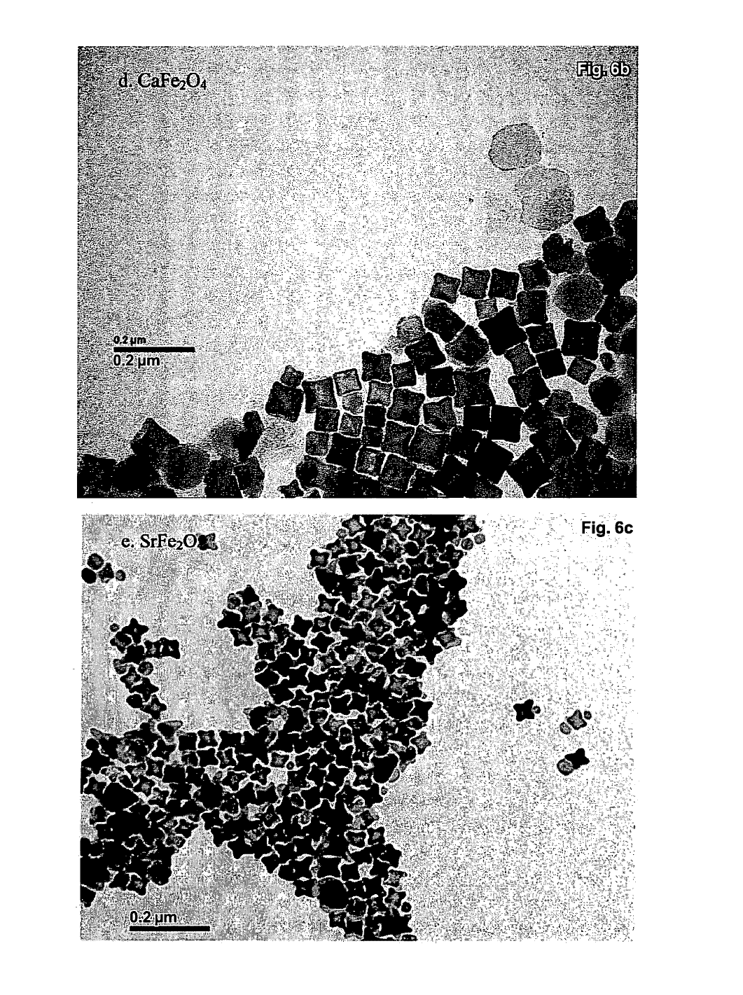

In a typical experiment, 0.4 mmol magnesium carbonate and 0.4 mmol ferrous acetate were dissolved in 3.0 mmol oleic acid at 320° C. to form a clear homogeneous solution. After it was cooled down to 60° C., 5 g oleylamine and 20 mL hexane were added; then it was transferred to the 100 mL Parr reactor 4950 and purged with N₂ gas. The mixture was quickly heated to 320° C. under stirring and maintained at the same temperature for 30 minutes to 3 h. The reaction was stopped by removing the heat and cooling down. After centrifugation, the precipitated products were either collected and dried or re-dissolved in an organic solvent such as hexane for storage. FIG. 6a shows a TEM image of ternary MgFe₂O₄ nanocube.

### Example 8

### Synthesis of Ternary Quantum Dots CaFe₂O₄

In a typical experiment, 0.3 mmol calcium nitrite and 0.6 mmol ferrous acetate were dissolved in 2.6 mmol oleic acid at 300° C. to form a clear homogeneous solution. After it was cooled down to 60° C., 6 g oleylamine and 20 mL hexane were added; then it was transferred to the 100 mL Parr reactor 4950 and purged with N₂ gas. The mixture was quickly heated to 320° C. under stirring and maintained at the same temperature for 30 minutes to 3 h. The reaction was stopped by removing the heat and cooling down. After centrifugation, the precipitated nanocrystals were collected and dried or re-dissolved in an organic solvent such as hexane for storage purpose. FIG. 6b shows a TEM image of ternary CaFe₂O₄ nanocube.

### Example 9

### Synthesis of SrFe₂O₄ (Ferrite Type)

2 mmol of iron (III) acetate and 2 mmol of strontium carbonate were dissolved in 6 mmol of oleic acid at 350° C. to form a clear homogeneous solution. After it was cooled, 2 mmol of oleylamine 15 ml of hexane were added; then it was transferred to the 100 mL Parr reactor 4950 and purged with N₂ gas. The mixture was quickly heated to 320° C. under stirring and maintained at the same temperature for 30 minutes to 2 h. The reaction was stopped by removing the heat and cooling down. The obtained mixture was exposed to centrifugation and the obtained nanocrystals collected and dried or re-dissolved in an organic solvent such as hexane for storage purpose. FIG. 6c shows a TEM image of ternary SrFe₂O₄ nanocubes.

### Example 10

### ZnFe₂O₄ Nanocrystals

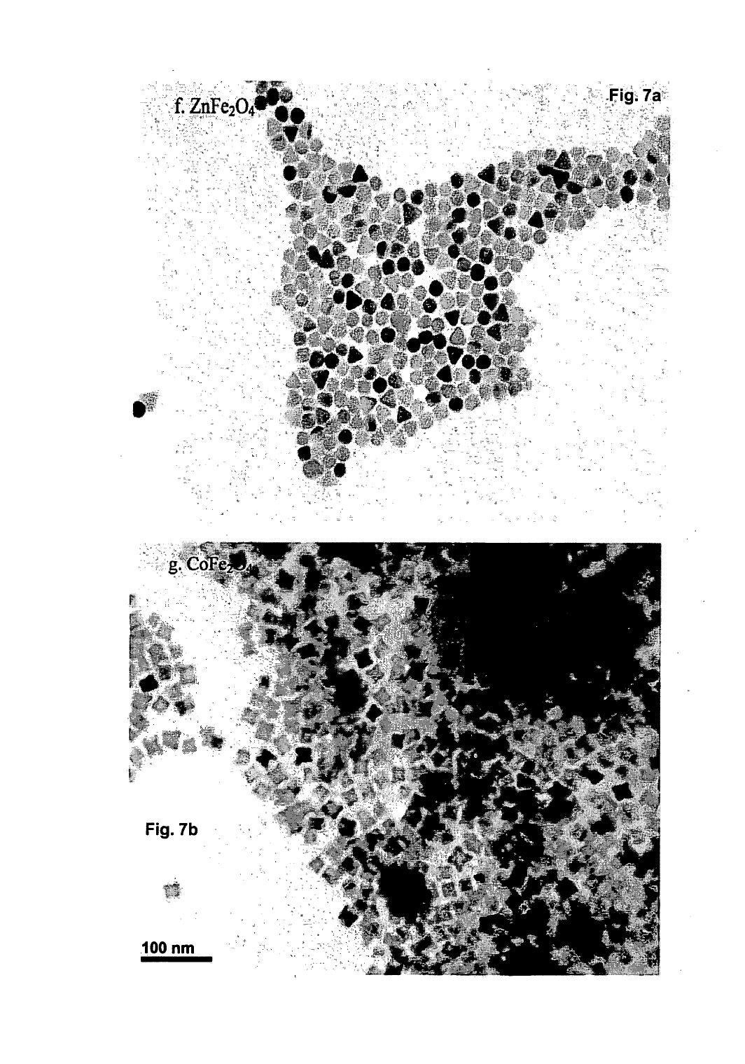

In a typical experiment, 0.3 mmol Zinc sulfate and 0.3 mmol Ferrous acetate were dissolved in 2.6 mmol oleic acid at 320° C. to form a clear homogeneous solution. After it was cooled down to 60° C., 6 g oleylamine and 20 mL hexane were added; then it was transferred to the 100 mL Parr reactor 4950 and purged with N₂ gas. The mixture was quickly heated to 320° C. under stirring and maintained at the same temperature for 30 minutes to 3 h. The reaction was stopped by removing the heat and cooling down. The final product was purified by a the simple centrifugation/dispersion process, i.e. the precipitated product was collected and dried, thereby obtaining a powder, or it was re-dissolved in an organic solvent such as hexane for storage. FIG. 7a shows a TEM image of ternary ZnFe₂O₄ nanocrystals.

### Example 11

### Synthesis of CoFe₂O₄ Nanocubes

In a typical experiment, 3.0 mmol cobalt carbonate (CoCO₃) and 3.0 mmol of ferrous acetate was dissolved in 7.5 mmol oleic acid at 200° C. to form a clear solution. After it was cooled down to room temperature, 20 mL hexane and 2 mL oleylamine were added, then it was transferred to 100 mL Parr reactor 4950 and purged with N₂ gas. The mixture was quickly heated to 300° C. under stirring and maintained at the same temperature for 1 h. The reaction was then stopped by simply removing the heat and cooling down. The final product was purified by a simple centrifugation/dispersion process, i.e. the precipitated nanocrystals were collected and dried or they were re-dissolved in an organic solvent such as hexane for storage. FIG. 7b shows a TEM image of the ternary metal oxide CoFe₂O₄ nanocubes.

### Example 12

### Synthesis of MnFe₂O₄ Nanocubes

In a typical experiment, 3.0 mmol manganese sulfate and 6.0 mmol ferrous acetate was dissolved in 15 mmol oleic acid at 200° C. to form a clear solution. After it was cooled down to room temperature, 35 mL hexane and 12 mL oleylamine were added, then it was transferred to 100 mL Parr reactor 4950 and purged with N₂ gas. The mixture was quickly heated to 320° C. under stirring and maintained at the same temperature for 30 minutes. The reaction was then stopped by simply removing the heat and cooling down. The final product was purified by a simple centrifugation/dispersion process (supra). FIG. 7c shows a TEM image of ternary metal oxide MnFe₂O₄.

### Example 13

### Synthesis of NiFe₂O₄

In a typical experiment, 3.0 mmol nickel sulfate and 2.0 mmol of ferrous acetate was dissolved in 7.5 mmol oleic acid at 200° C. to form a clear solution. After it was cooled down to room temperature, 20 mL hexane and 2 mL oleylamine were added, then it was transferred to 100 mL Parr reactor 4950 and purged with N₂ gas. The mixture was quickly heated to 300° C. under stirring and maintained at the same temperature for 1 h. The reaction was then stopped by simply removing the heat and cooling down. The final product was purified by a simple centrifugation/dispersion process, i.e. the precipitated nanocrystals can be collected and dried or be re-dissolved in an organic solvent such as hexane for storage.

### Example 14

### Synthesis of NiFe₂O₄ Nanocrystals

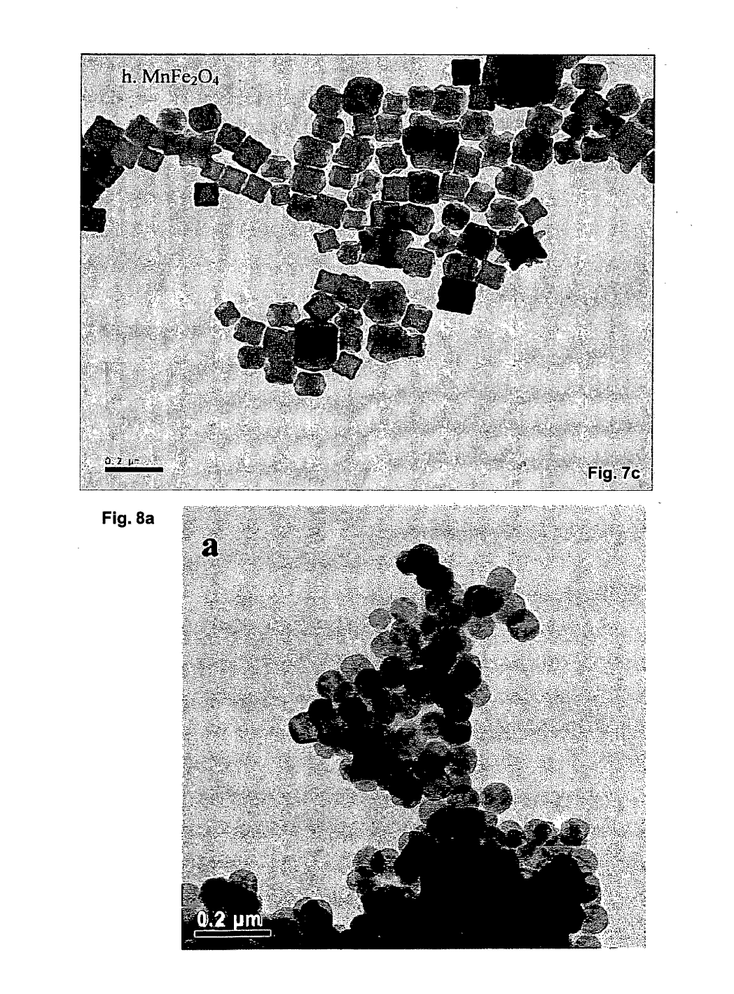

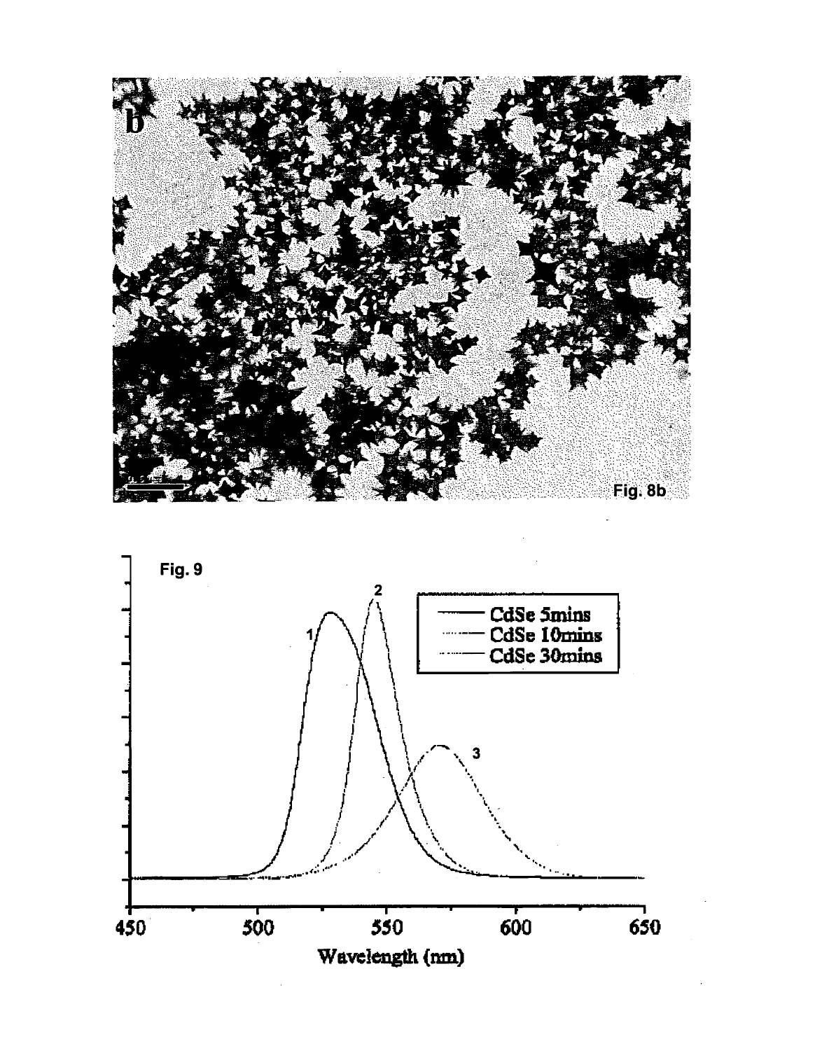

In a typical experiment, 1.0 mmol nickel acetate and 2.0 mmol iron (III) acetylacetonate were dissolved in 9.0 mmol oleic acid at 150° C. to form a homogeneous solution. After it was cooled down to 60° C., 5 mL trioctylamine and 20 mL hexane were added; then it was transferred to the 100 mL Parr reactor 4950 and purged with N₂ gas. The mixture was quickly heated to 320° C. under stirring and maintained at the same temperature for 30 min to 1 h. The reaction was stopped by removing the heat and cooling down. FIG. 8b shows a TEM image of ternary NiFe₂O₄ star-shape nanocrystals obtained in this solvothermal preparation. FIG. 8a depicts a TEM image of spherical NiFe₂O₄ nanocrystals prepared under ambient conditions. In which, 1.0 mmol nickel acetate and 2.0 mmol iron (III) acetylacetonate were dissolved in 9.0 mmol oleic acid at 150° C. together with 5 mL trioctylamine and 5 mL ODE to form a homogeneous solution. Then it was quickly heated to 320° C. under 1 atm with stirring and maintained at the same temperature for 30 min to 1 h. The reaction was stopped by removing the heat and cooling down. The obtained mixture was exposed to centrifugation and the obtained nanocrystals collected and dried or re-dissolved in an organic solvent such as hexane for storage purpose.

FIG. 8b depicts a TEM image of “star” shaped NiFe₂O₄ nanocrystals as an example of a ternary metal oxide, obtained using the solvothermal process of the invention. FIG. 8a shows a TEM image of a corresponding ternary metal oxide prepared under ambient condition. These TEM images illustrate that elevated pressure can favour modulation of morphologies of certain nanocrystals.

1. A method of forming a binary nanocrystal of the general formula M1A, wherein M1 is a metal selected from one of Group II, Group III, Group IV, Group VII and Group VIII of the Periodic System of Elements (PSE), and A is an element selected from Group VI or Group V of the Period System of Elements (PSE), the method comprising:
(i) forming a homogenous reaction mixture comprising a metal precursor containing the metal M1, the element A, and a non-polar solvent of low boiling point, and
(ii) bringing the homogenous reaction mixture under elevated pressure to an elevated temperature suitable for forming a nanocrystal.

2. A method of producing a binary nanocrystal of the general formula M1O, wherein M1 is a metal selected from one of Group II, Group III, Group IV, Group VII and Group VIII of the Periodic System of Elements (PSE), and O is oxygen, the method comprising:
(i) forming a homogenous reaction mixture comprising a metal precursor containing the metal M1 and an oxygen donor, and a non-polar solvent of low boiling point, and
(ii) bringing the homogenous reaction mixture under elevated pressure to an elevated temperature suitable for forming nanocrystals.

3. The method of claim 1, wherein the elevated pressure is from about 50 to about 100 atm (from about 50 to about 101 bar).

4. The method of claim 1, wherein the non-polar solvent of low boiling point has a boiling point of less than about 100° C. at atmospheric pressure (1013 mbar).

5. The method of claim 4, wherein the non-polar solvent of low boiling point has a boiling point of less than about 80° C. at atmospheric pressure (1013 mbar).

6. The method of claim 1, wherein the non-polar solvent of low boiling point is selected from the group consisting of hexane, chloroform, toluene, benzene, heptane, cyclohexane, dichloromethane, pyridine, carbon tetrachloride, carbon disulfide, dioxane, diethyl ether, diisopropylether, and tetrahydrofuran and mixtures thereof.

7.-25. (canceled)

26. The method of claim 1, wherein M1 is selected from Cd, Zn, Mg, Ca, Ba, Al, Ga, In, Pb, Sn, Sr, Mn, Fe, Co, Ni, and Ir.

27. (canceled)

28. The method of claim 1, wherein the element A is selected from S, Se, Te, O, P, Bi, and As.

29.-30. (canceled)

31. A method of forming a ternary nanocrystal of the general formula M1M2A, wherein M1 and M2 are independent from each other a metal selected from one of Group II, Group III, Group IV, Group VII and Group VIII of the PSE, and A is an element is selected from Group VI or V of the PSE, the method comprising:
(i) forming a homogenous reaction mixture comprising a metal precursor containing the metals M1 and M2, element A and a non-polar solvent of low boiling point, and
(ii) bringing the homogenous reaction mixture under elevated pressure to an elevated temperature suitable for forming a nanocrystal.

32. A method of forming a ternary nanocrystal of the general formula M1AB, wherein M1 is a metal selected from one of Group II, Group III, Group IV, Group VII and Group VIII of the PSE, and A and B are independent from each other elements selected from Group V or Group VI of the PSE, the method comprising:
(i) forming a homogenous reaction mixture comprising a metal precursor containing the metal M1, element A and element B, a non-polar solvent of low boiling point, and
(ii) bringing the homogenous reaction mixture under elevated pressure to an elevated temperature suitable for forming a nanocrystal.

33. A method of forming a nanocrystal of the general formula M1M2O, wherein M1 and M2 are independent from each other a metal selected from one of Group II, Group III, Group IV, Group VII and Group VIII of the PSE, and O is oxygen, the method comprising:
(i) forming a homogenous reaction mixture comprising a metal precursor containing the metals M1 and M2 and an oxygen donor, and a non-polar solvent of low boiling point, and
(ii) bringing the homogenous reaction mixture under elevated pressure to an elevated temperature suitable for forming a nanocrystal.

34. The method of claim 31, wherein the elevated pressure is from about 50 to 100 atm (from about 50 to about 101 bar).

35. The method of claim 31, wherein the non-polar solvent of low boiling point has a boiling point of less than about 100° C. at atmospheric pressure (1013 mbar).

36. The method of claim 35, wherein the non-polar solvent of low boiling point has a boiling point of less than about 80° C.

37. The method of claim 31, wherein the non-polar solvent of low boiling point is selected from the group consisting of hexane, chloroform, carbon tetrachloride, dichloromethane, toluene, benzene, heptane, cyclohexane, pyridine, carbon disulfide, dioxane, diethyl ether, diisopropylether, and tetrahydrofuran and mixture thereof.

38.-55. (canceled)

56. The method of claim 31, wherein M1 and M2 are independent from each other selected from Cd, Zn, Mg, Sr, Ca, Ba, Al, Ga, In, Pb, Sn, Mn, Fe, Co, Ni, and Ir.

57. (canceled)

58. The method of claim 31, wherein the elements A and B are independent from each other selected from S, Se, Te, P, Bi, and As.

59.-61. (canceled)

62. A method of forming a quaternary nanocrystal of general formula M1M2AB, wherein M1 and M2 are independently a metal selected from one of Group II, Group III, Group IV, Group VII and Group VIII of the PSE, and A and B are independent from each other an element selected from Group VI or Group V of the PSE, the method comprising:
(i) forming a homogenous reaction mixture comprising a metal precursor containing the metal M1 and the metal M2, the element A, the element B and a non-polar solvent of low boiling point, and
(ii) bringing the homogenous reaction mixture under elevated pressure to an elevated temperature suitable for forming a nanocrystal.

63. The method of claim 62, wherein the elevated pressure is from about 50 to about 100 atm (from about 50 to about 101 bar).

64. The method of claim 62, wherein the non-polar solvent of low boiling point has a boiling point of less than about 100° C. at atmospheric pressure (1013 mbar).

65. The method of claim 62, wherein the non-polar solvent of low boiling point has a boiling point of less than about 80° C. at atmospheric pressure (1013 mbar).

66.-85. (canceled)

86. The method of claim 62, wherein the metals M1 and M2 are independent from each other selected from Cd, Zn, Mg, Ca, Ba, Al, Ga, In, Pb, Sn, Sr, Mn, Fe, Co, Ni, and Ir.

87. (canceled)

88. The method of claim 62, wherein the elements A and B are independent from each other selected from S, Se, Te, O, P, Bi, and As.

89.-92. (canceled)
